(19) United States
(12) Patent Application Publication
(10) Pub. No.: US 2011/0191752 A1
(43) Pub. Date: Aug. 4, 2011

(54) Method and System for Debugging of Software on Target Devices

(76) Inventors: Christophe Cleraux, Sene (FR); Benoit Perrin, Vannes (FR)

(21) Appl. No.: 12/696,381

(22) Filed: Jan. 29, 2010

(51) Int. Cl. G06F 9/44; G06F 9/45

(52) U.S. Cl. 717/129; 717/143

(57) ABSTRACT

A system including a memory for storing a set of instructions executable by a processor. The instructions being operable to receive a definition of code information, parse the code information and generate a byte code expression for the code information, the generating including resolving the symbols of the code information, wherein the byte code expression relates to only memory access, register access and numerical operations of the code information.

### BACKGROUND

The ability to build, debug, and deploy software programs onto a target device is critical to software development. Debugging often involves monitoring variables, parameters, and/or resources used in a software program. One conventional method of monitoring involves inserting print statements within the program's code and performing a diagnostics session. Monitoring may also be performed during specific times of the program's execution. For example, breakpoints are often used to pause or terminate program execution, allowing the developer perform a diagnostics session in order to view the status of the variables, parameters, and resources at the specified times. However, the conventional debugging methods described above are limited. Since changes to the program code are required during debugging, the program must be recompiled and re-executed in order to view the results of these changes. Thus, the conventional debugging methods cannot be applied to programs that are currently being executed without interrupting the operation of the programs.

Additional diagnostics interactions with the program code on the target device may also be required, such as downloading patches, extracting data related to program performance and servicing, and/or collecting parameter data relating to a business operating the program. The performance of these interactions may require diagnostics data storage on the target device, thereby limiting the resource of the target device and increasing the overhead required to effectively operate the program code once deployed onto the target device.

### SUMMARY OF THE INVENTION

A system including a memory for storing a set of instructions executable by a processor. The instructions being operable to receive a definition of code information, parse the code information and generate a byte code expression for the code information, the generating including resolving the symbols of the code information, wherein the byte code expression relates to only memory access, register access and numerical operations of the code information.

A system including a memory for storing a set of instructions executable by a processor. The instructions being operable to receive, from a first device, a byte code expression for code information, wherein the byte code expression relates to only memory access, register access and numerical operations of the code information and execute, on a second device, the byte code expression.

A debugging system having a debugger on a host device receiving a definition of at least one of a conditional breakpoint within a code on a target device and calling a routine with an arbitrary set of parameters on the target device and generating a byte code expression for the one of the conditional breakpoint and the routine and a debugging agent on a target device executing the byte code expression.

### BRIEF DESCRIPTION OF THE DRAWINGS

FIG. 1 shows an exemplary system for allowing a user to set one or more conditional breakpoints while having a debugging agent on a target device perform the evaluation of the condition(s) according to an exemplary embodiment.

FIG. 2 shows an exemplary method for allowing a user to set one or more conditional breakpoints while having a debugging agent on a target device perform the evaluation of the condition(s) according to an exemplary embodiment.

FIG. 3 shows an exemplary system allowing a user to call a routine with an arbitrary set of parameters on the target while having the target perform the call according to an exemplary embodiment.

FIG. 4 shows an exemplary method allowing a user to call a routine with an arbitrary set of parameters on the target while having the target perform the call according to an exemplary embodiment.

### DETAILED DESCRIPTION

The exemplary embodiments may be further understood with reference to the following description and the related appended drawings, wherein like elements are provided with the same reference numerals. The exemplary embodiments are related to systems and methods used to develop, test and debug software. Specifically, exemplary embodiments are related to systems and methods for scripting a breakpoint on a target device, or simply target, using a debugging agent. Furthermore, the exemplary embodiments are related to calling a routine on the target using the debugging agent. It should be noted that the target device may be a remote embedded device deployed in an operating environment. Remote interaction with the target may be accomplished through the use of inserting software modules into running code (e.g., software application, kernel, driver, etc.) on the deployed target. For example, the software module may serve as a software patch for an application on the device, or collect data from the deployed device for predictive servicing, or extract information from the device for diagnostic or business related purposes.

According to exemplary embodiments, the debugging agent of the software module may allow software developers and engineers to use the software modules to aid in the monitoring of the application performance on the deployed target. Debugging may be defined as a methodical process of finding and reducing the number of bugs, or defects, in a computer program or a piece of electronic hardware, thereby making it behave as expected. In addition, debugging may involve identifying the circumstances in which the defect occurs, locating the source of the defect within the program, and fixing the defect.

In a conventional system, debugging a remote embedded device typically requires numerous messages to be exchanged between a host device and the target embedded device. In the conventional debugging system, a conditional breakpoint expression is evaluated on the host side. Accordingly, this conventional system requires for a breakpoint to be notified each time the breakpoint is hit. In addition, the host must evaluate the expression and resume the target if the expression is not met.

Furthermore, in order to perform a function call, the host debugger on the host must prepare a stack frame by calling a register modification application program interface (“API”). An API may be defined as a set of functions or procedures that an operating system provides to support requests made by computer programs. According to the conventional debugging system, a further API is then called to perform the actual function call. Another call to the register modification API is needed to restore the registers as they were before. The exemplary embodiments eliminate the need for these numerous message exchanges for both evaluating conditional breakpoints and calling a routine with an arbitrary set of parameters on the target.

Software applications are often created on a host computing device and ported to a target device. This type of development is typical for embedded devices. An embedded device may be described as any device that includes a processor or microcontroller that executes software to carry out desired functions. Normally, an embedded device has fewer resources than a general purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc.

The exemplary embodiments will be described with reference to a diagnostic tool for such embedded devices. However, those skilled in the art will understand that the present invention may be implemented in, for example, a diagnostic tool for software executing on any type of device. As will be described in greater detail below, a debugger may be installed onto the target device in order to perform diagnostic evaluations on the target side, while collecting useful diagnostic information during the development of the software application. Exemplary embodiments will be described with reference to the development of software applications for these target devices in both networked and non-networked environments.

As will be described in greater detail below, the exemplary embodiments provide for debugging code on the target deployed in a field environment. Specifically, the exemplary embodiments may allow a user to set conditional breakpoints, wherein the evaluation of the conditions may be performed on the target (e.g., by a debugging agent on the target). This will dramatically reduce the time needed to evaluate the condition, and thus, improve the time required for debugging. Furthermore, the exemplary embodiments may allow a user to call a routine with an arbitrary set of parameters on a target, and the debugging agent on the target may perform the call. Specifically, the debugging agent on the target may parse byte code stream received from a host debugger, prepare a stack frame, perform the call, and provide a return value to the host debugger. Accordingly, this may dramatically reduce the time needed to call a routine, and thus, further improve the time required for debugging.

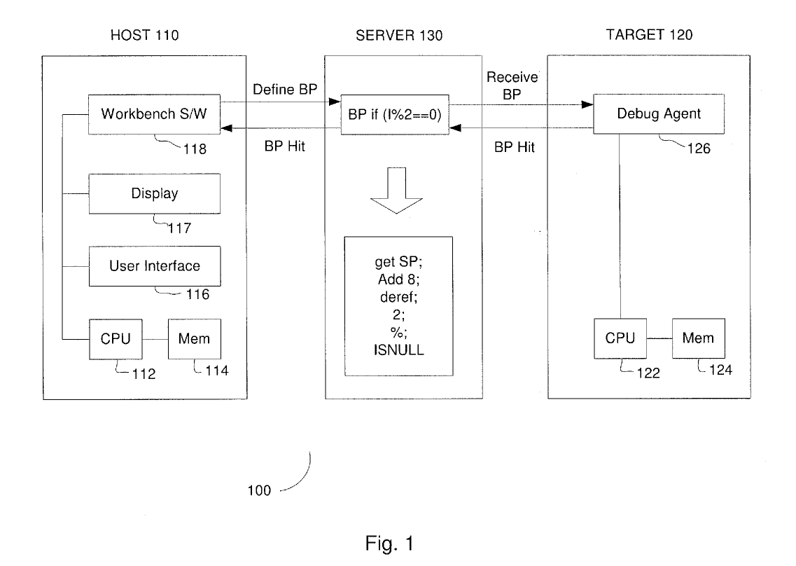

FIG. 1 shows an exemplary system 100 for allowing a user to set one or more conditional breakpoints while having a debugging agent 126 on a target device 120 perform the evaluation of the condition(s) according to an exemplary embodiment. In addition to the target device 120, the system 100 includes a server 130 and a host device 110 in communication with the target device 120 via the server 150. While the server 130 is illustrated in FIG. 1 as the link between the host 110 and the target 120, it should be noted that the functions of the server 130 may be incorporated within the host 110, itself. In other words, the host 110 may communicate directly with the target 120. Accordingly, the depiction of the host 110 and server 130 in FIG. 1 as a separate entity is merely for illustrative purposes, and is not intended to limit the configurations and components of any embodiments of the system 100.

In one embodiment, both the target 120 and the host 110 may be located in a lab environment, while in another embodiment, the target 120 and/or the host 110 may be in a field environment. For example, the target 120 may be deployed in a warehouse, office, etc., while the host 110 resides in a laboratory or central server location. The host 110 may include conventional computing components such as a processing unit 112 (e.g., a CPU, a microprocessor, an embedded controller, etc.) and a memory 114 (e.g., Random Access Memory, Read-only Memory, a hard disk, etc.). Likewise, the target 120 may also include a processing unit 122 and a memory 124, as well as the debugging agent 126. Communication between the target 120 and the host 110 occurs over a communication link, which may be a wired (e.g., Ethernet, serial port, Universal Serial Bus, etc.) or wireless (e.g., Bluetooth, IEEE 802.1x, etc.) connection.

The host 110 may further include a user interface 116, a display 117 and workbench software 118. The user interface 116 enables a software developer to interact with the host 110 by receiving instructions and data requests. The user interface 116 may comprise any number of standard input and/or output devices, such as a keyboard (not shown), a mouse (not shown), a display 117, etc. The display 117 may provide the developer with a visual representation of programming code operating between the host 110 and the target 120. In addition, the display 117 may include a debugging graphical user interface (“GUI”). The debugging GUI will be described in further detail below. Throughout the description, the term developer will be used to refer to a user of the system and method disclosed herein. Specifically, the user may be on either the host side or the target side, wherein examples of the user may include, but are not limited to, a customer, a software engineer, a test engineer, a quality assurance engineer, support personnel, etc. Furthermore, a developer may be one or more third-party engineers, wherein the third-party engineer may build on top of the technology established by first-party developers and/or programmers.

As illustrated in FIG. 1, the host 110 may include at least one conditional breakpoint, such as, for example, “BP if (I %2=0)”. This conditional breakpoint may be provided to the target 120 via the server 130. As will be described in greater detail, the user at the target 120 may add instructions to the conditional breakpoint that are to be executed once the condition is met. For example, these instructions may include getting a sensorpoint, adding a value in a register address, adjusting dereference address, etc. The evaluation of the condition (e.g., if (I %2==0)) is performed on the target side by breakpoint evaluation code. Once the condition is met (e.g., a breakpoint hit event occurs), the target 120 may inform the host 110 via the server 130 and the conditional instructions may be performed accordingly.

Through the user interface 116, the developer may instruct the host 110 to transmit data to and/or from the target 120. The data may include conditional breakpoints, sensorpoint modules, and monitoring data. A conditional breakpoint may be described as code or instructions that cause a break to occur in execution only if a specific condition is satisfied (e.g., met). A sensorpoint may be, for example, an instrumentation point inserted into a program code, thereby allowing software developers to perform diagnostic applications on the code. However, the exemplary embodiments are not limited to using sensorpoints, but may be implemented using any mechanism that can instrument a program. As will be discussed in detail below, sensorpoint modules comprise program code that the developer can implement on the target 120. Monitoring data may include any relevant data that the developer desires to receive from the target 120, such as device information, alarms and error messages, log information, and audit information (e.g., information related to users modifying devices and/or sensorpoint modules). The monitoring data may also relate to device type. For example, if the target 120 is a cell phone, the monitoring data may include call usage information, signal strength information, etc. The monitoring data may be transmitted automatically (e.g., at predetermined intervals) or upon request by the developer. For example, the user may request to view a log file generated by the target 120 in order to view specific program output.

The workbench software 118 is a software development tool used by the developer to create, modify, and debug software programs. Using the workbench software 118, the user can create conditional breakpoints and sensorpoint modules, write and edit code for the breakpoints and sensorpoints, compile the code, abstract a parameter profile from the compiled code, and save the breakpoints and sensorpoints to a database or as a local file. Once saved, the breakpoints and sensorpoints may be selected for transmission to the target 120.

The workbench software 118 may comprise a software suite that includes any number of individual software development programs, such as a compiler, a debugger, a source code analyzer, a text editor, etc. These individual programs may either be run independently of a running application or within a main development program. According to the exemplary embodiment, the debugger may parse an expression, such as a symbolic ‘C’ expression. The debugger may then generate byte code, such as, for example, in a dwarf3 expression. The debugger may resolve all of the symbolic aspects and generate byte code that deals specifically with memory and register access, as well as basic numerical expressions (e.g., +, −, *, /, %, etc.). As will be described in greater detail, the generated expression of byte code may then be transmitted to the target 120 for target-side evaluation performed by the debugging agent 126.

Those skilled in the art will understand that the breakpoint and sensorpoint code as written may not be the same as the actual code executed by the target 120. For example, the actual code may be an executable binary file created as a result of compiling and linking the sensorpoint code. The binary may be included in the sensorpoint module as an object file. In addition, the sensorpoint module may include multiple files, such as source, header and library files. These files may be installed individually or together with the entire sensorpoint module.

As described above, the target 120 may include the debugging agent 126 that may communicate with the host 110, specifically, for example, with the workbench software 118 via the communication link. The debugging agent 126 may coordinate the sending and receiving of data. Instructions and data requests are received by the debugging agent 126 and processed accordingly. Specifically, the debugging agent 126 may evaluate any breakpoints, including complex breakpoints, on the target side. Accordingly, the debugging agent 126 may be capable of at least limited architecture dependent information, such as register mapping, in order to correctly interpret the generated expression from the host 110. It should be noted that the debugging agent 126 may be implemented in hardware, software, or a combination thereof.

The target 120 may operate using a user code, which comprises a program running in an operating system or a stand-alone program. The user code may be written in any programming language (e.g., C/C++, Java, Assembly language, etc.). The user code may be any program that the developer desires to run on the target 120. For example, the user code may be a main program or subroutine being developed for implementation on the target 120. The user code may include source, header, library, object, and other data files.

The target 120 may also include breakpoint evaluation code executable by the debugging agent 126. Similar to the user code, the breakpoint evaluation code may include source, header, library and object files. According to the exemplary embodiments described herein, the user may set one or more conditional breakpoints. Specifically, the user may describe the condition that is necessary to trigger the conditional breakpoint, as well as the additional instructions to be performed if the conditions of the breakpoint are met (e.g., if the breakpoint is triggered, or “hit”). Thus, the breakpoint evaluation code may allow the condition to be monitored on the target side and inform the host 110 (e.g., via the server 130) when the breakpoint hit event occurs. It should be noted that the additional instructions may be directed to any one of the target 120, the server 130, and the host 110. Thus, the debugging agent 126 may provide not only notification of the hit event, but also provide the instructions to the server 130 and the host 110.

According to the example illustrated in FIG. 1, the user may add conditions that may retrieve a sensorpoint, add a value in a register address, adjust dereference address, etc. (e.g., “get SP; Add 8; deref; 2; %; ISNULL”). The breakpoint evaluation code may evaluate these conditions. If these conditions are met, the debugging agent 126 may notify the host 110 via the server 130. However, if these conditions are not met, the user code on the target 120 may resume operation. The host 110 may avoid performing any evaluations of the breakpoints, and communication between the host 110 and the target 120 may be greatly reduced. Thus, users of the exemplary system 100 may set breakpoints with complex conditions on a target 120, while minimizing the exchanges between the debugger of the workbench software 118 on the host side and the debug agent 126 on the target side. Accordingly, users will gain a better experience with complex breakpoint setting, especially when the communications between the host 110 and the target 120 is limited, slow, or sporadic.

It should be noted that the breakpoint evaluation code may be executed by the running application via branch instructions inserted into the running application (e.g., the executable binary). The breakpoint evaluation code may include keywords for logging purposes, wherein the keywords may correspond to both conditional breakpoint directives and instrumentation points identifying the locations of the user code.

Those skilled in the art will understand that the system 100 and the various components described for the host 110 and the target 120 are only exemplary and are being used to illustrate an exemplary embodiment for debugging the user code running on the target 120 according to the exemplary embodiment. However, debugging according to the exemplary embodiments may be implemented on systems that do not include the components described herein, e.g., conditional breakpoints, sensorpoints, etc. Those skilled in the art will understand that the functionality described for debugging may be implemented on other systems that include other components. Specifically, the functionality described for the evaluating the breakpoints may be performed on any independent code, wherein the independent code is compiled separately from a target code and then inserted into the target code. Thus, the functionality of concern is the ability to debug software code running target 120, while performing the evaluation of the breakpoints on the target side.

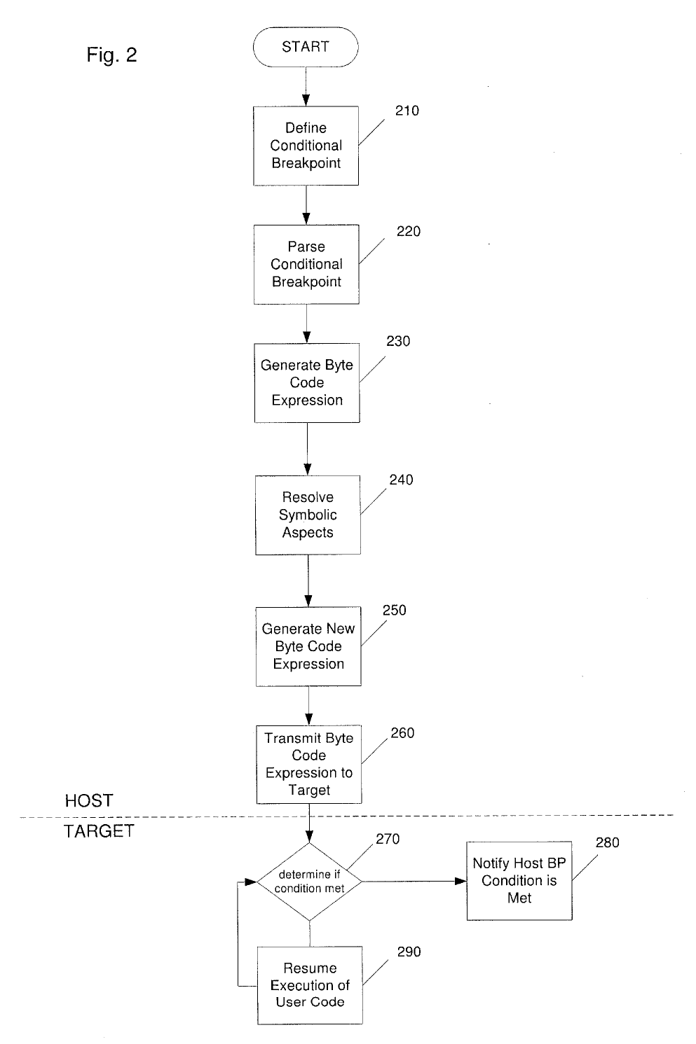

FIG. 2 shows an exemplary method 200 for allowing a user to set one or more conditional breakpoints while having a debugging agent 126 on a target device 120 perform the evaluation of the condition(s) according to an exemplary embodiment. It should be noted that method 200 that will be discussed with reference to components of the system 100 of FIG. 1.

Beginning with step 210, a conditional breakpoint may be created using the workbench software 118. As previously discussed, the conditional breakpoint may be code or instructions that cause a break in execution to occur only if a specific condition is met. The workbench software 118 may be accessed using the user interface 116, or from the target 120 if the target 120 has its own user interface. If the conditional breakpoint is a newly created module, then breakpoint code is written, packaged within the module and stored in the database. Alternatively, if the conditional breakpoint already exists, the existing breakpoint code is modified and saved. For example, the user may create a condition breakpoint expression as a symbolic ‘C’ expression, such as “if (I %2==)”. This expression may be provided to the debugger of the workbench software 118.

In step 220, the debugger may parse the conditional breakpoint expression. Specifically, the debugger may analyze a sequence of tokens within the expression in order to determine their grammatical structure with respect to a given syntax. The debugger may build a data structure (e.g., a parse tree, an abstract syntax tree, other hierarchical structure) implicit in the input tokens.

In step 230, the debugger may generate a byte code expression. For example, the byte code may be a dwarf3 expression. Byte code expression may be described as instruction sets designed for efficient execution by a software interpreter, as well as being suitable for further compilation into machine code. Unlike source code, byte codes are compact numeric codes, constants, and references (e.g., numeric addresses) that encode the result of parsing and semantic analysis of factors such as type, scope, and nesting depths of program objects. In step 240, the debugger may resolve all the symbolic aspects within the byte code expression. In step 250, the debugger may generate new byte code that deals only with memory and register access, as well as basic numerical operations (+, −, *, /, %, etc.).

In step 260, the newly generated byte code expression may be transmitted to the target 120. Specifically, the expression may be sent to the debug agent 126. As described above, the communications between the host 110 and the target 120 may be accomplished via the server 130. Thus, at this point in the process the monitoring for the defined conditional breakpoints is placed under the control of the debugging agent 126, meaning that the host 110 does not need to remotely monitor the running code for breakpoints. As described above, this greatly decreases the amount of communications needed between the target 120 and the host 110 during the debugging process. Those of skill in the art will understand that this does not necessarily mean that the host 110 will not monitor for any breakpoints, but merely that the debugging agent 126 will monitor for those specific conditional breakpoints that have been defined by the developer and the generated byte code expression has been sent to the debugging agent 126.

In step 270, the debug agent 126 on the target 120 may evaluate the generated byte code expression. In other words, the debug agent 126 may determine whether or not the condition of the conditional breakpoint has been met. If the condition is met, the method may advance to step 280. However, if the condition is not met, the method may advance to step 290, wherein the target 120 resumes execution. Accordingly, the method 200 may then return to step 270, wherein the debug agent 126 determines if a further breakpoint is hit.

In step 280, the debug agent 126 may notify the host 110 that the condition of the breakpoint expression has been met, thus the conditional instructions may be performed by one or more of the target 120, the host 110, and/or the server 130. As described in detail above, the act of monitoring for the conditional breakpoints at the target 120 eliminates multiple communications between the target 120 and the host 110.

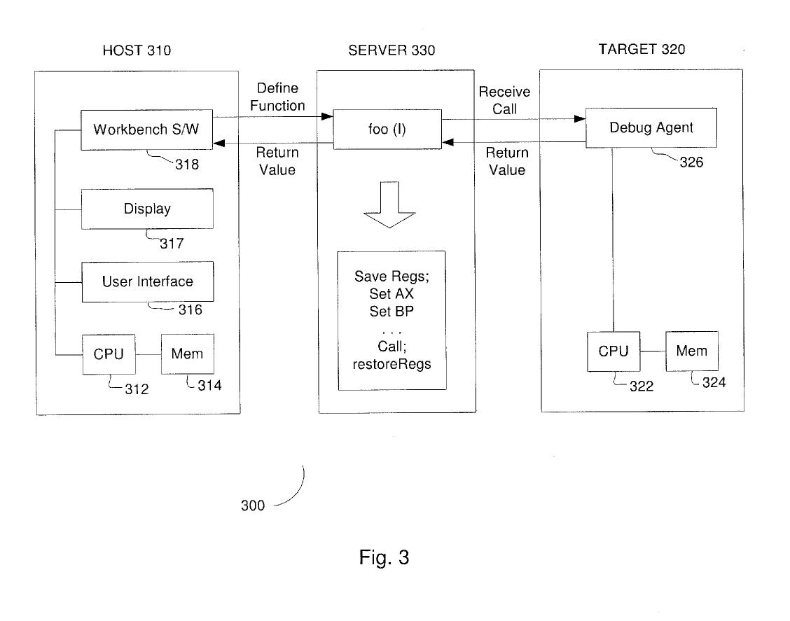

FIG. 3 shows an exemplary system 300 allowing a user to call a routine with an arbitrary set of parameters on the target 320 while having the target 320 perform the call. The exemplary system 300 includes the same basic components as the exemplary system 100 of FIG. 1. As will be described below, the functionality of the components is also similar, except that instead of defining a conditional breakpoint and generating a byte code expression for the conditional breakpoint, the developer will define a routine or function with an arbitrary set of parameters and the host 310 will generate a byte code expression for the routine which then may be executed at the target 320 by the debugging agent 326 to provide the return value. Thus, the operation of the system 300 is similar to the operation of system 100.

Turning to the system, 300, in addition to the target device 320, the system 300 includes a server 330 and a host device 310 in communication with the target device 320 via the server 350. While the server 330 is illustrated in FIG. 3 as the link between the host 310 and the target 320, it should be noted that the functions of the server 330 may be incorporated within the host 310, itself. In other words, the host 310 may communicate directly with the target 320. Accordingly, the depiction of the host 310 and server 330 in FIG. 3 as a separate entity is merely for illustrative purposes, and is not intended to limit the configurations and components of any embodiments of the system 300.

The host 310 may include conventional computing components such as a processing unit 312 (e.g., a CPU, a microprocessor, an embedded controller, etc.) and a memory 314 (e.g., Random Access Memory, Read-only Memory, a hard disk, etc.). Likewise, the target 320 may also include a processing unit 322 and a memory 324, as well as the debugging agent 326. Communication between the target 320 and the host 310 occurs over a communication link, which may be a wired (e.g., Ethernet, serial port, Universal Serial Bus, etc.) or wireless (e.g., Bluetooth, IEEE 802.1x, etc.) connection.

The host 310 may further include a user interface 316, a display 317 and workbench software 318, similar to the host 110 described in FIG. 1. For instance, the developer may instruct the host 310 to transmit data to and/or from the target 320 through the user interface 316 and the workbench software 318 is a software development tool used by the developer to create, modify, and debug software programs

As illustrated in FIG. 3, the host 310 may include at least one function call, such as, for example, “Call foo (I)”. This function call may be provided to the target 320 via the server 330. As will be described in great detail, the user at the target 320 may evaluate the function call, prepare a stack frame, perform the call, and return a value to the host 310. For example, the target 320 may save registers, set AX, set breakpoint(s), call a routine, restore registers, etc. Accordingly, the evaluation of the function call (e.g., foo (I)) is performed on the target side by call evaluation code. Once the call is performed, the target 120 may return the value back to the host 110 via the server 130.

The workbench software 318 may comprise a software suite that includes any number of individual software development programs, such as a compiler, a debugger, a source code analyzer, a text editor, etc. These individual programs may either be run independently of a running application or within a main development program. According to the exemplary embodiment, the debugger may parse a function argument and use debug information to prepare a stack frame. The debugger may then generate a stream byte code, such as, for example, in a dwarf3 expression. The debugger may resolve all of the symbolic aspects and generate a new stream of byte code that deals specifically with memory and register access, as well as basic numerical expressions (e.g., +, −, *, /, %, etc.). As will be described in greater detail, the generated stream of byte code may then be transmitted to the target 320 for target-side evaluation performed by the debugging agent 326.

As described above, the target 320 may include the debugging agent 326 that may communicate with the host 310, specifically, for example, with the workbench software 318 via the communication link. The debugging agent 326 may coordinate the sending and receiving of data. Instructions and data requests are received by the debugging agent 326 and processed accordingly. Specifically, the debugging agent 326 may parse the byte code stream in order to prepare a stack frame, perform the call, restore the register set, and provide the host 310 with a return value. Thus, the debugging agent 326 may evaluate any generated stream of byte code expressions on the target side. Accordingly, the debugging agent 326 may be capable of at least limited architecture dependent information, such as register mapping, in order to correctly interpret the generated expression from the host 310. It should be noted that the debugging agent 326 may be implemented in hardware, software, or a combination thereof.

The target 320 may include both user code and call evaluation code executable by the debugging agent 326. Similar to the user code, the call evaluation code may include source, header, library and object files. According to the exemplary embodiments described herein, the user may call a routine with an arbitrary set of parameters (e.g., arbitrary arguments) on the target 320. The call evaluation code may allow for one or more APIs to be called target side and inform the host 310 (e.g., via the server 130) of the return values once the call is performed. It should be noted that the additional APIs (e.g., register modification, function call, register restoration) may all be performed at the target 320 by the debugging agent 326. Thus, the debugging agent 326 may reduce excessive communication between the target 320 and the host 310.

According to the example illustrated in FIG. 3, the user may add conditions that may save registers, set AX, set breakpoints, perform the function call, restore the register, etc. (e.g., “saveRegs; Set AX; Set BP; . . . ; call; restoreRegs”). The call evaluation code may evaluate this stack frame and the debugging agent 326 may return what is left of the stack to the host 310 via the server 330. Thus, users of the exemplary system 300 may call routines on the target 120 with arbitrary arguments, while minimizing the exchanges between the debugger of the workbench software 318 on the host side and the debug agent 326 on the target side. Accordingly, users will gain a better experience with function calls, especially when the communications between the host 310 and the target 320 is limited, slow, or sporadic.

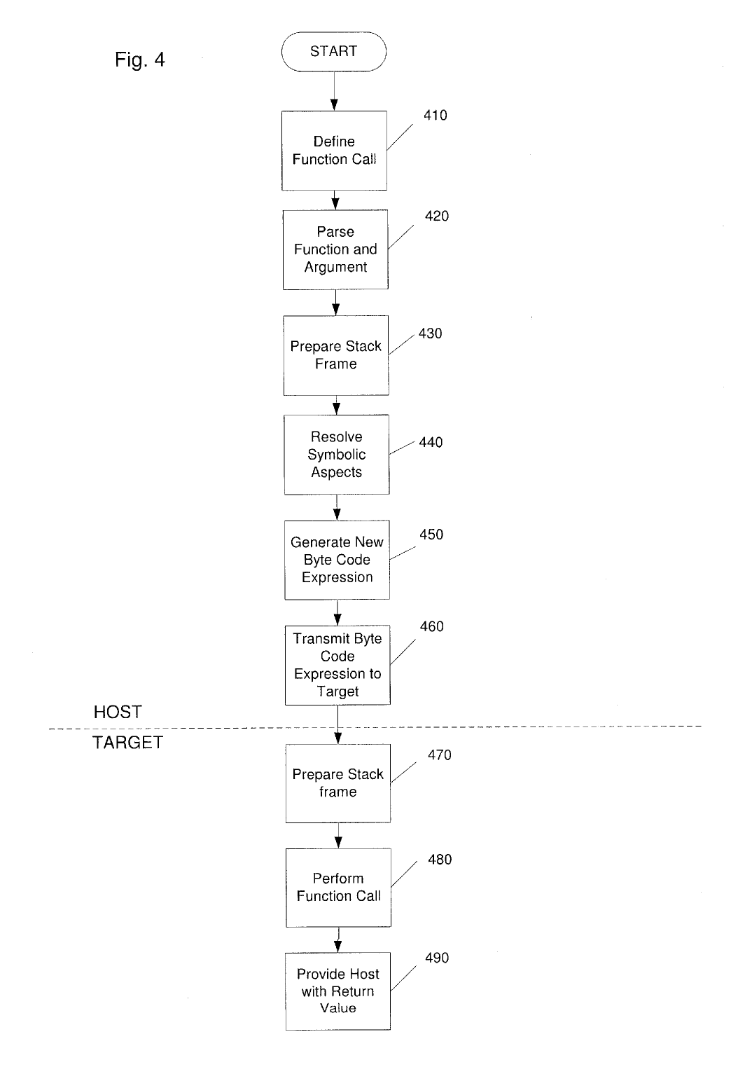

FIG. 4 shows an exemplary method 400 for allowing a user to call a routine with an arbitrary set of parameters on the target 320 while having the target 320 perform the call according to an exemplary embodiment. It should be noted that method 400 that will be discussed with reference to components of the system 300 of FIG. 3.

Beginning with step 410, a function call may be created using the workbench software 318. A function call may be described as a portion of code within a larger program that performs a specific task while being relatively independent of the remaining code. The workbench software 318 may be accessed using the user interface 316, or from the target 320 if the target 320 has its own user interface. For example, the user may create the exemplary function call “foo (I)”. This expression may be provided to the debugger of the workbench software 318.

In step 420, the debugger may parse the function argument of the call. Specifically, the debugger may analyze a sequence of tokens within the call in order to determine their grammatical structure with respect to a given syntax. The debugger may build a data structure (e.g., a parse tree, an abstract syntax tree, other hierarchical structure) implicit in the input tokens.

In step 430, the debugger may use debug information to prepare a stack frame and generate a stream of byte code. For example, the byte code may be a dwarf3 expression. In step 440, the debugger may resolve all the symbolic aspects within the byte code expression. In step 450, the debugger may generate new byte code that deals only with memory and register access, as well as basic numerical operations (+, −, *, /, %, etc.).

In step 460, the newly generated byte code expression may be transmitted to the target 320. Specifically, the expression may be sent to the debug agent 326. As described above, the communications between the host 310 and the target 320 may be accomplished via the server 330. Thus, at this point, the host 310 is no longer involved with the running of the routine at the target 320. The host 310 is merely waiting for the return value as sent by the debug agent 326 when it runs the routine at the target 320, thereby eliminating multiple communications between the host 310 and the target 320.

In step 470, the debug agent 326 on the target 320 may parse the byte code stream and prepare the stack frame. In other words, the debug agent 326 may prepare the stack frame by calling a register modification API to adjust the register(s), calling an API to perform the call, calling the register modification API to restore the register(s), etc.

In step 480, the debug agent 326 may perform the function call. Specifically, the debug agent 326 may perform each of the instructions within the stack frame and restore the register set upon completion of the function call.

In step 490, the debug agent 326 may provide the host 310 with the return value. Accordingly, since the function calls with the arbitrary set of parameters are performed on the target side, the time required to call a routine may be dramatically reduced. Specifically, the communication between the host 310 and the target 320 may be reduced, thereby speeding up the debugging time.

Throughout this description, it has been described how conditional breakpoints and routines (referred to as “code information”) may be defined by a developer on a user interface of a debugger and byte code expressions are generated by the debugger. These byte code expressions are then ported to a debugging agent on a target device and executed by the debugging agent. However, it should be clear to those of skill in the art that the present invention is not limited to only these examples. There may be other types of code information beyond conditional breakpoints and routines that could be defined in the same manner. Furthermore, the present invention is not limited to debuggers or debugging agents. That is, the definition of the code information may be performed on another tool that is not a debugger (e.g., a compiler, an optimizer, etc.) and the agent on the target device does not need to be related to or only to debugging of the target.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A system including a memory for storing a set of instructions executable by a processor, the instructions being operable to:
receive a definition of code information;
parse the code information; and
generate a byte code expression for the code information, the generating including resolving the symbols of the code information, wherein the byte code expression relates to only memory access, register access and numerical operations of the code information.

2. The system of claim 1, wherein the instructions are further operable to transmit the byte code expression to a target device.

3. The system of claim 1, wherein the code information is a conditional breakpoint.

4. The system of claim 3, wherein the instructions are further operable to receive an indication from a further device that the conditional breakpoint has been satisfied by code running on the further device.

5. The system of claim 1, wherein the code information is a routine including an arbitrary set of parameters.

6. The system of claim 5, wherein the generating the byte code expression further includes preparing a stack frame.

7. The system of claim 5, where wherein the instructions are further operable to receive a return value from a further device based on the execution of the routine by the further device.

8. A system including a memory for storing a set of instructions executable by a processor, the instructions being operable to:
receive, from a first device, a byte code expression for code information, wherein the byte code expression relates to only memory access, register access and numerical operations of the code information; and
execute, on a second device, the byte code expression.

9. The system of claim 8, wherein the code information is a conditional breakpoint.

10. The system of claim 9, wherein the execution of byte code expression determines whether a condition of the conditional breakpoint is satisfied by the second device.

11. The system of claim 10, wherein the instructions are further operable to send an indication to the first device when the condition is satisfied.

12. The system of claim 8, wherein the code information is a routine including an arbitrary set of parameters.

13. The system of claim 12, wherein the execution of the byte code expression includes preparing a stack frame at the second device.

14. The system of claim 13, wherein the instructions are further operable to send a return value to the first device based on the execution of the byte code expression for the routine.

15. A debugging system, comprising:
a debugger on a host device receiving a definition of at least one of a conditional breakpoint within a code on a target device and calling a routine with an arbitrary set of parameters on the target device and generating a byte code expression for the one of the conditional breakpoint and the routine; and
a debugging agent on a target device executing the byte code expression.

16. The debugging system of claim 15, wherein the debugging agent performs a function call, and provides the host device with a return value upon completion of the functional call.

17. The debugging system of claim 16, wherein the debugging agent modifies a register set prior to performing the function call, and restores a register set upon completion of the function call.

18. The debugging system of claim 15, wherein the debugging agent informing a host device that a condition of the conditional breakpoint has been met.

19. The debugging system of claim 15, wherein the debugger comprises a display for displaying a source code corresponding to the code on the target device.
